(19) United States
(12) Patent Application Publication
(10) Pub. No.: US 2024/0327197 A1
(43) Pub. Date: Oct. 3, 2024

(54) HORSE WHIP

(71) Applicant: LeMieux Limited, Hampshire (GB)

(72) Inventors: Robert Paul Victor LeMieux, Hampshire (GB); James Vincent Crowley, Hampshire (GB)

(21) Appl. No.: 18/503,704

(22) Filed: Nov. 7, 2023

(30) Foreign Application Priority Data
Mar. 29, 2023 (GB) 2304583.4

(51) Int. Cl. B68B 11/00

(52) U.S. Cl. CPC B68B 11/00

(57) ABSTRACT

A horse whip (1) comprising a handle portion (2) and a contact portion (3), wherein the contact portion comprises a substantially cylindrical portion at a far end region and a round tapered portion adjacent to said substantially cylindrical portion, which round tapered portion tapers away from the substantially cylindrical portion.

### TECHNICAL FIELD

The present invention relates to horse whips.

### BACKGROUND

Horse/riding whips, which may also be termed known horse/riding crops, are known in various different forms. They typically comprise a handle and a flexible shaft. Attached to the end of the shaft is a flap, which can be brought into contact with the flank, side or hindquarters of the horse by the rider. Horses are usually trained to move forward on receiving a tap on their flank, side or hindquarters. A rider can also use a whip to bring about an adjustment when a horse strays off course. Use of a whip can also be effective without needing to contact the horse, by moving the whip through the air within the field of vision of the horse.

We seek to provide an improved horse whip.

### SUMMARY

According to a first aspect of the invention, there is provided a horse whip having a handle portion, which may be an upper or top part of the whip, and a contact portion, which may be a lower part of the whip,
wherein the contact portion may comprise a substantially cylindrical portion at a far end region and a round tapered portion at a near end region which may taper towards the handle portion.

The contact portion may be elongate. The contact portion may accommodate various lengths (of core elements). The whip may be manufactured in different, fixed lengths. The whip may of a variable length, and a user can set or adjust to a desired length.

The contact portion may extend to meet the handle portion or finish short with a length of inner shaft showing or being exposed between the two portions.

The horse whip may be termed a baton horse whip, as it may be viewed as somewhat similar to the form/shape of a baton or a bat. The horse whip may be in the form of an elongate unitary entity.

By ‘contact portion’ we include that part of the horse whip which, in use, is intended (to be suitable) to be brought into contact with the side/flank of the horse.

The whip of the invention may be used in general riding activities and disciplines, such as show jumping, and eventing, as well as flat racing and jumps racing.

There may be a substantially continuous transition between the contact portion and the handle portion.

The contact portion may be substantially contiguous with the handle portion. The contact portion may abut the handle portion (at an interface or junction between the two parts).

A near end of the contact portion may be bonded to a far end of the handle portion.

There may be a junction at which a far end of the handle portion meets a proximal end of the contact portion.

There may be provided a joint or connector, which is located between the handle portion and the contact portion, and which serves to join said handle portion to said contact portion. Each of the handle portion and the connector portion may be in contact with the connector/joint. The joint preferably covers a core of the whip. It may be that such connector/joint is not considered as being either the handle portion or the contact portion.

The (extent of the) contact portion may terminate adjacent or proximal to the handle portion.

Where there is a gap or spacing between the (distal end of the) contact portion and the (distal end of the) handle portion, this may be no more than 200 mm. For example, such a gap may be in the range 1 mm to 10 mm, or may lie in any other sub-range below 200 mm.

The tapered portion may comprise a sub-portion which narrows in cross-sectional size away from the cylindrical portion and towards the handle portion.

Being a substantially round outer surface it may that said surface is substantially absent of presenting any corners or edges.

The round outer surface may be of substantially circular cross-section, in transverse section of the contact portion.

At least an extent of the contact portion may comprise a substantially cylindrical outer surface. By substantially cylindrical we include a shape that is not perfectly cylindrical, and that is near-cylindrical.

A far-end portion of the contact portion may comprise a substantially cylindrical outer surface. A near-end portion of the contact portion may comprise an outer surface of substantially frusto-conical shape. The frusto-conical shape may taper towards the handle portion. The frusto-conical shape may have straight/linear or curved sides.

The contact portion may comprise a primary sub-portion and a secondary sub-portion, and the primary sub-portion, located at a distal end region, intended as the primary contact to the horse, and the secondary sub-portion intended as being suitable for contact with the horse but which is less likely in use to contact the horse, and the secondary sub-portion located between the handle portion and the primary contact portion.

The contact portion may be provided with a plurality of through-holes. The through-holes may be apertures which have open distal ends. The through-holes may be termed vents.

The through-holes may be formed offset to a central longitudinal axis of the whip. The cylindrical portion of the contact portion may be provided with the through-holes.

The (baton) whip may comprise an elongate core, which may be termed a shaft or rod, which supports the handle portion and the contact portion.

The core may be covered substantially in its entirety collectively by the handle portion and by the contact portion.

Substantially none of the core may be exposed between the contact portion and the handle portion.

Each of the contact portion and the handle portion may be provided with an internal elongate void or lumen which is arranged to receive the core.

During assembly of the baton whip, each of the contact portion and the handle portion is arranged to slide onto a (single) core.

The contact portion may be softer than the core and/or the handle portion.

The contact portion may be of a material which is of lower density than the material of the core and/or the material of the handle portion. The material in the contact portion, and for example the density of the material, may have shock and/or pressure absorbing properties.

The core may be formed substantially of fibre glass.

The contact portion may consist of a unitary formed piece.

The handle portion may consist of a unitary formed piece.

By ‘formed’, we include, but do not limit to, moulding.

At least one of the contact portion and the handle portion may be in the form of a sleeve.

The contact portion may be made of foam/an expanded polymer. The contact portion may include padding and may have shock and pressure absorbing properties.

The contact portion may be formed of substantially a single material.

The handle portion may comprise a grip material.

The handle portion may be made of rubber, or a rubberized material.

The handle portion may comprise one or more grip formations.

A major part of the length of the outer surface of the whip collectively comprises the handle portion and the contact portion. The contact portion may constitute/present between 40% to 60% of the overall length of the outer surface of the whip.

The contact portion may form a longer extent of the length of the outer surface as compared to the handle portion.

Substantially the entire length of the outer surface of whip collectively includes the handle portion and the contact portion. Put another way, there may be substantially no part of the outer surface of the whip which is neither the contact portion nor the handle portion.

That portion of the whip that includes the handle may be heavier than that part of the whip that includes the contact portion. The relative weighting of the handle portion versus the contact portion may be such as to achieve an optimised balance both in the rider's hand and whilst the whip passes through the air.

In use, the contact portion may be arranged for flexure relative to the handle portion. The flexion of the shaft passing through the centre of the contact portion may vary in its flexibility from soft (and therefore more flexible) to hard (and therefore less flexible).

The contact portion may be described as occupying a (far) end portion of the whip, and the handle portion may occupy a near-end portion.

The invention may be viewed as a baton-form horse whip with a handle portion and a contact portion, which are supported on an elongate core, and the handle portion and the contact portion collectively cover substantially all of or a major portion of the length of the core.

According to another aspect of the invention there is provided a horse whip comprising a handle portion and a contact portion, wherein the contact portion is provided with an array of open-ended apertures which extend through the contact portion. The apertures may allow air to pass through, and so may be termed vents.

Any of the above aspects of the invention may comprise, either singularly in combination, one or more features disclosed above, in the description and/or shown in the drawings. This disclosure includes that any features disclosed herein can be used to supplement any of the above aspects, and for such purpose none of those features, individually, is inextricably linked to any other such feature, notwithstanding that multiple features may be disclosed in the context of a particular embodiment in relation to other features.

### BRIEF DESCRIPTION OF THE DRAWINGS

Various embodiments of the invention will now be described, by way of example only, in which:

FIG. 1 is a perspective view of a horse whip,

FIG. 2 is a perspective view of the horse whip of FIG. 1,

FIG. 3 is a plan view of the horse whip of FIG. 1

FIG. 4 is another plan view of the horse whip of FIG. 1, but at a ninety degree orientation relative the view in FIG. 3,

FIG. 5 is an exploded view of the horse whip of FIG. 1, which shows the various component parts thereof,

FIG. 6 is a longitudinal cross-section view of the horse whip of FIG. 1,

FIG. 7 is a plan view of a different embodiment of a horse whip, and

FIG. 8 is a plan view of the embodiment of Figure in an orientation which is a ninety degree rotation as compared to the orientation in FIG. 7.

### DETAILED DESCRIPTION

There is now described a novel horse whip. As is explained in more detail below, the whip form is generally in a shape similar to that of a baton or bat, with improved use characteristics as compared to known horse whips.

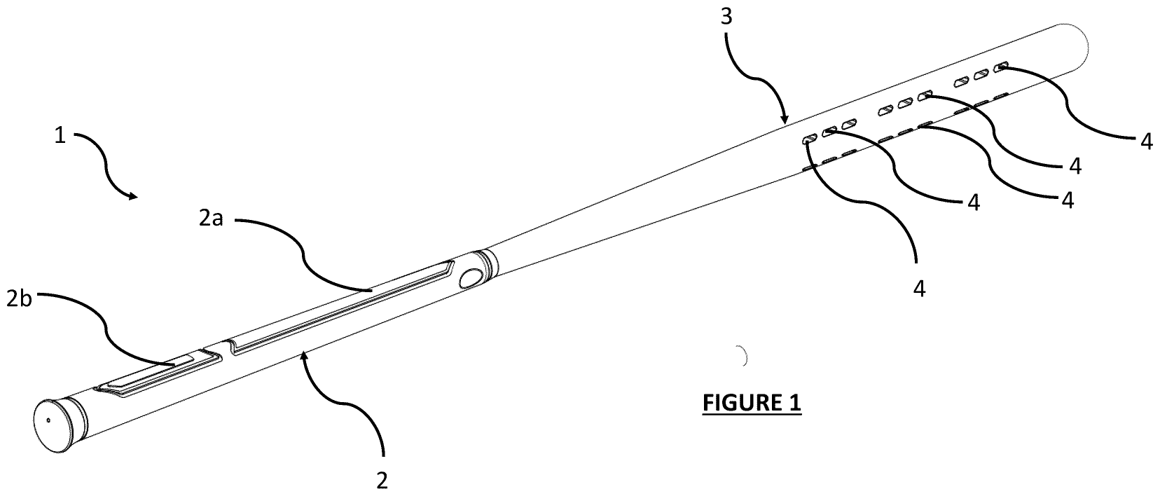

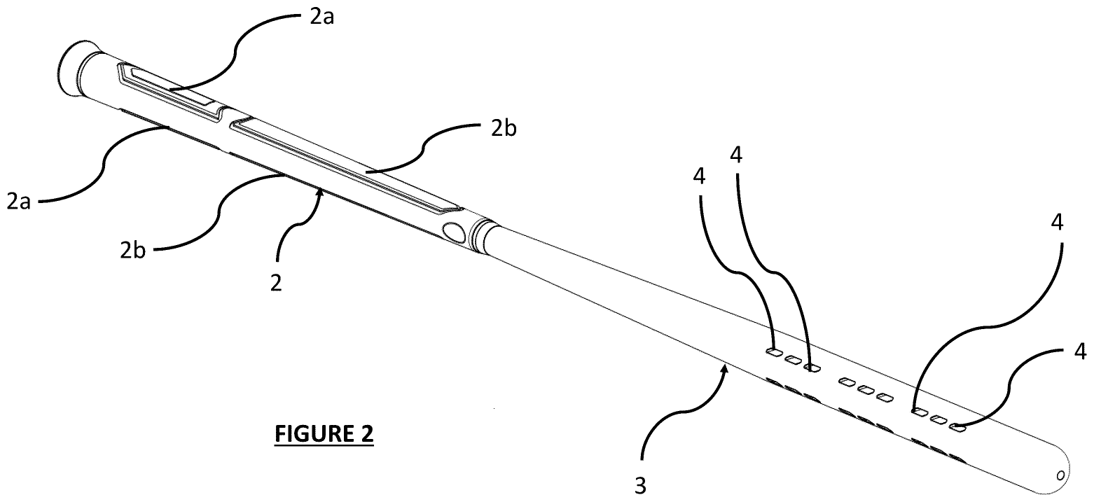

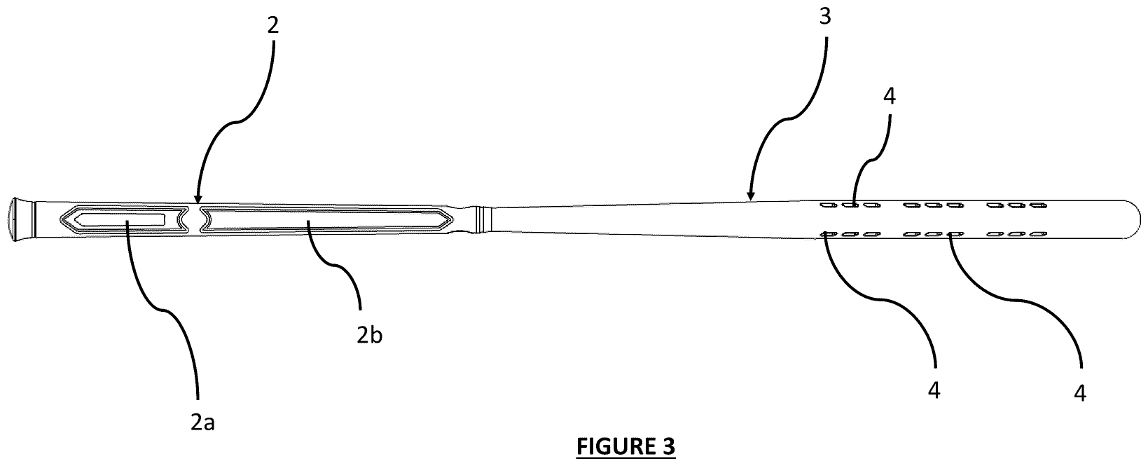

With reference to FIGS. 1, 2 and 3, there is shown a horse whip 1 which comprises a handle and a contact part 3. The handle 2 is designed to held by a rider, and the contact part 3 is arranged to in use, to be brought into contact with the flank/side of the horse.

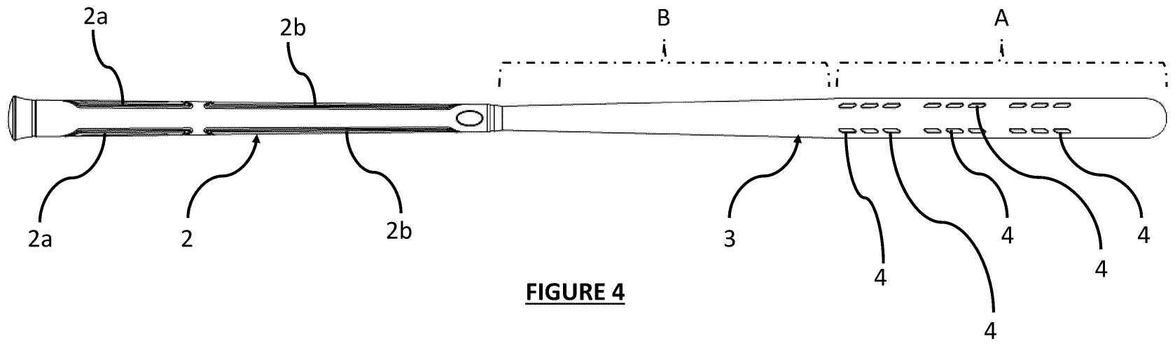

With reference to FIG. 4, the contact portion 3 comprises a first portion A and a second portion B. The first portion A is that part of the contact portion which is principally intended to contact the horse, when the whip is used. The portion A has an outer surface which is of substantially cylindrical shape. At one end, the free-end, the portion A has a rounded distal tip, and at its opposite end transitions smoothly into the second portion B.

The cylindrical portion A is provided with multiple through-holes 4. Each of the through-holes 4 has two opposed open ends. The through-holes 4 are provided offset from a central longitudinal axis of the whip 1. The through-holes are arranged in three groups of three. The holes 4 can be described as being of slot-shape.

The tapered portion B of the contact portion 3, is also of round (cross-sectional) shape, but tapers from the portion A to the handle 2. The tapered portion B is thus of frusto-conical shape, and provides a smooth transition from the cylindrical portion A to the handle. The portion B is not primarily intended to contact the horse, but is such that if this portion happens to come into contact with the horse when the whip is used, it will impact the horse to the same, similar or lesser extent than the cylindrical portion A.

In a variant embodiment, the tapered portion B may be of a different material as compared to the cylindrical portion A, but still covers the core, is still round, and is still suitable for contact against the flank/side of the horse. In another embodiment, the each of the cylindrical portion A and the tapered portion B are formed as respective unitary items.

The handle is a moulded item which is formed from a rubber or rubberized material, and is provided with two sets of grip formations 2a and 2b, each set located on opposite positions on the handle.

The contact portion 3 is made from a foam material/expanded polymer.

One or both of the contact portion and the handle may be formed by moulding.

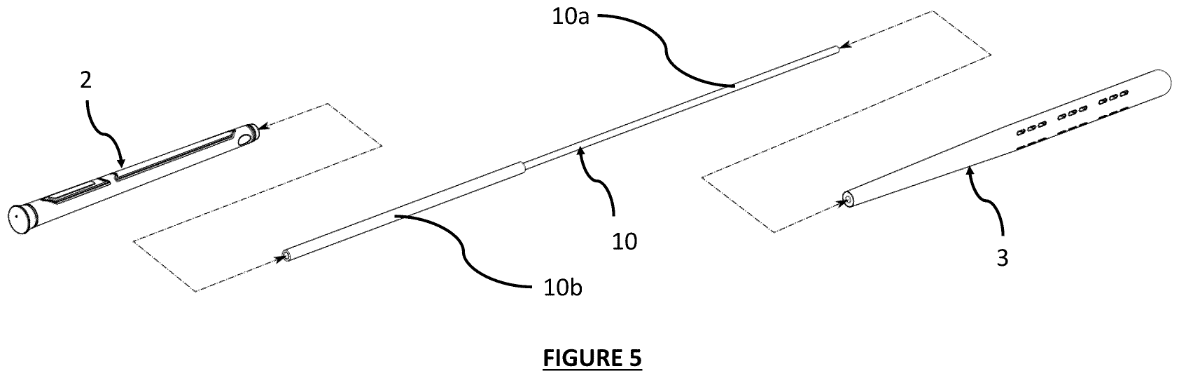

With reference to FIG. 5, each of the handle and the contact portion is of unitary sleeve form, which are arranged to be received on a rod or shaft 10 (and the shaft forming a core of the whip 1 and which is further described below). Each of the handle and the contact portion being of sleeve form are provided with a respective lumen, into which a respective end region of the shaft 10 is centrally received.

The rod 10 comprises a fibre glass shaft 10a, and allows for a very strong inner core that is also very light weight and thin, and flexible (along its length). An outer sleeve 10b fits over an end region of the shaft 10a, and is arranged to be received inside the lumen of the handle.

Turning to the contact portion, this is provided with a plurality of through apertures 4, which serve as vents. The apertures are formed by removing sections of foam material. The vents 4 are arranged in two aligned sets of three apertures each. Each vent has opposed open distal ends. Each set of vents is located offset from a central longitudinal axis/extent of the core 10. The vents may be of different shape than those shown in the exemplary embodiment, and there may be more or fewer of them. Although all of the vents 4 are shown as having the same orientation, some or all of the vents may be arranged at different orientations. For example, one set of vents may be arranged at a ninety degree orientation to another set of vents.

The vents 4 aid in optimising the aero dynamic properties of the whip allowing it to travel through the air more smoothly and to be used more accurately (since it will be less impacted by air resistance). The vents 4 are aligned to allow air to pass directly through the contact portion.

Horses can travel at speeds of 30-40 mph which increases the air resistance to which the contact end is subjected as it is moved through the air, which may otherwise affect the deflect an intended path of the contact end.

The provision of the vents 4 also helps achieve a target weight of the whip. Further in relation to the weighting of the whip, the handle has greater weight that the contact portion. This weight proportioning is achieved by the material of the handle being of higher density than the material of the contact portion 3.

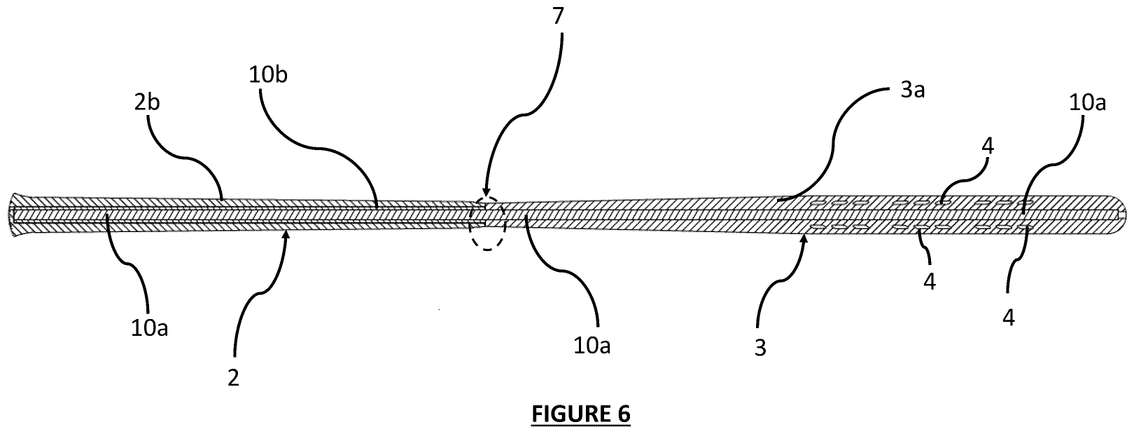

Reference is made to FIG. 6, which shows a longitudinal cross-section of the whip 1. At the region referenced 7, there is an interface between the handle and the contact portion in which a near-end of the contact portion contacts with a far-end of the handle. At this interface there is substantially no gap between the two parts. The ends of the parts may simply abut, or may be affixed by way of a glue or bonding substance. This being so means that there is substantially no part of the core 10 which is exposed along its length, it being covered collectively by the contact portion and the handle portion. In a variant embodiment there may be a (small) gap between the proximal ends of the handle and the contact portion. In a further embodiment, there may be a connector/joint component which is supported by the core, and is located between the handle and the contact, and to which each of the proximal ends of the handle and the contact portion are in contact with (either by way of abutment or as a bonded connection).

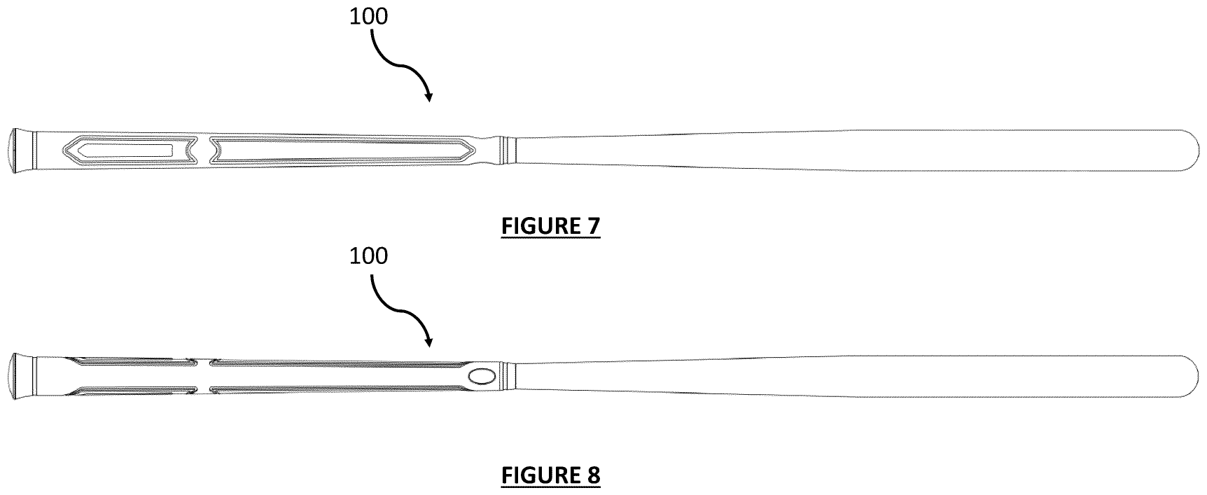

In an alternative embodiment, the contact portion is not provided with vents. Such an embodiment is shown in FIGS. 7 and 8. The horse whip is 100 is substantially identical to the horse whip 1, save that it is not provided with vents in the contact portion.

In a further alternative embodiment, a connector piece may be provided between the handle and the contact portion, which connector piece covers the core.

In another embodiment, the handle and the contact portion do not meet or are not adjacent, and there is a separation between them, which may expose the core.

1. A horse whip comprising a handle portion and a contact portion,
wherein the contact portion comprises a substantially cylindrical portion at a far end region and a round tapered portion adjacent to said substantially cylindrical portion, which round tapered portion tapers away from the substantially cylindrical portion.

2. The horse whip of claim 1 wherein the contact portion extends proximally to the handle portion.

3. The horse whip of claim 1 in which there is a substantially continuous transition between the contact portion and the handle portion.

4. The horse whip of claim 1 in which the contact portion is substantially contiguous with the handle portion.

5. The horse whip of claim 1 in which a distal end of the contact portion terminates adjacent to the handle portion.

6. The horse whip of claim 1 in which there is a gap between a distal end of the contact portion and a distal end of the handle portion, which is no more than 20 mm.

7. The horse whip of claim 1 in which the tapered portion reduces in cross-sectional size towards the handle portion.

8. The horse whip of claim 1 in which at least an extent of the contact portion comprises a substantially cylindrical outer surface.

9. The horse whip of claim 1 in which the tapered portion comprises an outer surface of substantially frusto-conical shape.

10. The horse whip of claim 1 which comprises an elongate core which supports the handle portion and the contact portion.

11. The horse whip of claim 1 in which the core is covered substantially in its entirety collectively by the handle portion and by the contact portion.

12. The horse whip of claim 11 in which substantially none of the core is exposed between the contact portion and the handle portion.

13. The horse whip of claim 1 in which each of the contact portion and the handle portion is provided with an internal elongate void or lumen which is arranged to receive an elongate core.

14. The horse whip of claim 1 in which the contact portion is of a material which is of lower density than the material of the handle portion.

15. The horse whip of claim 1 in which at least one of the contact portion and the handle portion consists of a unitarily formed piece.

16. The horse whip of claim 1 in which the contact portion is made of foam material or an expanded polymer.

17. The horse whip of claim 1 in which a weighting proportion of the whip is such that the portion of the whip that includes the handle is heavier than that part of the whip that includes the contact portion.

18. The horse whip of claim 1 in which the contact portion is provided with a plurality of through-holes.

19. The horse whip of claim 18 in which the through-holes may be formed are offset to a central longitudinal axis of the whip.

20. The horse whip of claim 18 in which the cylindrical portion of the contact portion is provided with the through-holes.
